(19) United States
(12) Patent Application Publication
(10) Pub. No.: US 2019/0213551 A1
(43) Pub. Date: Jul. 11, 2019

(54) SYSTEM AND METHOD OF COLLECTING PROJECT METRICS TO OPTIMIZE DISTRIBUTED DEVELOPMENT EFFORTS

(71) Applicant: International Business Machines Corporation, Armonk, NY (US)

(72) Inventors: Nianjun Zhou, Danbury, CT (US); Carl Engel, Hoschton, GA (US); Craig A. Rahenkamp, Niwot, CO (US); Wesley Gifford, Ridgefield, CT (US); Gregory H. Westerwick, Durango, CO (US); Ken Saloranta, Winnipeg (CA); Krishna C. Ratakonda, Yorktown Heights, NY (US); John F. Bisceglia, Johns Island, SC (US)

(21) Appl. No.: 15/866,678

(22) Filed: Jan. 10, 2018

(51) Int. Cl. G06Q 10/10; G06Q 10/06

(52) U.S. Cl. CPC G06Q 10/103; G06Q 10/06316; G06Q 10/1097; G06Q 10/06313; G06Q 10/0633; G06Q 10/063118

(57) ABSTRACT

A computer-implemented end-to-end system for optimizing distributed development projects may include a Software as a Service (SaaS) collecting historical project metrics. A productivity factor analyzer may perform analysis of one or more productivity factors with one or more quantifiers to define an impact of a team composition and task split on a project development. A task splitter may perform identification of one or more split points that minimize negative impacts from a geographically distributed environment in communication and team collaboration. An indifference curve identifier processing device may identify trade-offs for client metrics and develop a set of contours for different development options. A development optimizer may calculate the team composition, and task splits based on the one or more split points, the set of contours, and the impact of a team composition and task split on the project development. A SaaS service automatically allocates task assignments to corresponding target workers.

### FIELD

The present application generally relates to computers and computer applications, and more particularly to an automated system that creates and assigns execution work tasks based on completed project metrics submitted by entities.

### BACKGROUND

Currently, when a company develops a new project or product, a common practice is to utilize geographically distributed teams to achieve cost savings, for example, for a cost effective development and execution plan. Without a comprehensive historical database with constant updates, however, it may not be possible to create an efficient plan with controlled risk. The current best practices in the project estimation and planning are based on common sense, proprietary technology, or limited harvested historical project data. Such development is not very efficient and faces a risk of failure due to a lack of enough data for creating a model that can predict. Thus, there is a need for methods and systems to make a computer processing of the data collection, analysis and model creation, and task assignment be more efficient on execution of future projects.

In planning, estimating and executing project development efforts, companies have traditionally taken the low cost of resources as a primary factor. However, in view of the current trend toward geographical distributed developments efforts, e.g., where development resources may be distributed geographically across different locations, there may be many other factors that contribute to efficient project execution or product development. To achieve efficient task assessment and assignment in a geographically distributed environment, a large historical data set is typically required, all of which businesses typically do not own or have limited information.

### BRIEF SUMMARY

A computer-implemented method and system of collecting, assessing, planning and executing for distributed development project may be provided. The method, in one aspect, may include a service (e.g., Software as a Service platform) to allow a user or a system to automatically to submit project development metrics, including but not limited to material and labor cost, productivity, labor hours, split ratio, duration, the size of the project and the quality of final project. In another aspect, the method may include, for example, the service, analyzing one or more productivity factors with one or more quantifiers to define an impact of a team composition and task split on a project or product development. The method may also include identifying one or more split points that minimize negative impacts from a geographically distributed environment in communication and team collaboration. The method may further include identifying trade-offs for client metrics and developing a set of contours for different development options. In another aspect, the method may automatically notify and assigning assigned tasks to geographically distributed individuals through updating their assignment and/or sending a notification, for example, via electronic mails or another messaging implementation.

The method and system, in one aspect, may provide an integrated solution to combine a harvesting mechanism to collect fragmented project metrics, generating estimation and execution plan, and task assignment, and may enhance the productivity of project or product development and reduce the development time.

A system for collecting, assessing and planning for distributed project or product development, in one aspect, may include a device (for example, a hardware processor) collecting project development metrics, including but not limited to material and labor cost, productivity, labor hours, split ratio, duration, project size and project quality. A productivity factor analyzer processing device may perform analysis of one or more productivity factors with one or more quantifiers to define an impact of a team composition and task split on a project development. A task splitter processing device may perform identification of one or more split points that minimize negative impacts from a geographically distributed environment in communication and team collaboration. An indifference curve identifier processing device may identify trade-offs for client metrics and develop a set of contours for different development options. A development optimizer processing device may determine the team composition, and task splits based on the one or more split points, the set of contours, and the impact of a team composition and task split on the project development. In another aspect, the device may automatically notify and assign assigned tasks to geographically distributed individuals through updating their assignments and/or sending notifications such as electronic-mails and/or text or other messages.

A computer readable storage medium storing a program of instructions executable by a machine to perform one or more methods described herein also may be provided.

Further features, as well as the structure and operation of various embodiments, are described in detail below with reference to the accompanying drawings. In the drawings, like reference numbers indicate identical or functionally similar elements.

### BRIEF DESCRIPTION OF THE DRAWINGS

FIG. 1 is a diagram illustrating high-level components of a service in one embodiment in the present disclosure for an end-to-end system to collect historical metrics, estimate and assign to the future project plan.

FIG. 2 is a diagram illustrating data structures of collected data in one embodiment for registration, harvested historical project metrics, and task assignment for a worker, for example, a developer.

FIG. 3 is a diagram illustrating a data flow of an end-to-end system in one embodiment.

FIG. 4 is a diagram illustrating components of a system in the present disclosure in one embodiment for estimating the distributed project and risk using various combinations of development resources to create an optimal task split, team split, and schedule for project or solution development.

FIG. 5 is a flow diagram illustrating a method in one embodiment for estimating the distributed project and risk using various combinations of development resources to create an optimal task split, team split, and schedule for project or solution development.

FIG. 6 illustrates a client utility function in one embodiment of the present disclosure.

FIG. 7A and FIG. 7B illustrate an example of a task dependency tree in one embodiment of the present disclosure.

FIG. 8 illustrates a schematic of an example computer or processing system that may implement a system in one embodiment of the present disclosure.

FIG. 9 illustrates a cloud computing environment in one embodiment.

FIG. 10 shows a set of functional abstraction layers provided by cloud computing environment in one embodiment of the present disclosure.

### DETAILED DESCRIPTION

A system, method, and techniques may be provided that implement a shared service for enabling assessing development efforts and creating task assignments. In one embodiment, a shared service may be provided through collecting from existing and completed projects, for example, from an individual business, and also providing an estimation of service execution back to the individual business for a future project. A shared service, such as Cloud Software (Software as a Service (SaaS)) may be utilized in one embodiment to provide a service enabling automatical collecting project data and/or project execution information, and task assignment information for a new or updated project plan. Such system may promote information symmetry that achieves efficiency. A simple example is an application that collects fragments of information from individual users and provides the overall information to the users.

In one aspect, a service such as Cloud SaaS with an application programming interface (API) may be provided that allows for integration with data harvesting practice and project estimating and/or planning, for example, where both the owners of historical data (historical project metrics) and the consumer of the estimating and planning are distributed and fragmented in business. Such integration may reduce computer system or hardware processor cycle time in processing fragmented information such as the project metrics data, and estimation, planning and project tasks assignment.

In assessing development efforts for a given project, for example, an information technology (IT) project, especially in a modern environment where development resources may be scattered geographically, there are many factors that affect the efficiency of the project development, for example, factors that affect duration, quality, cost and risk that should be taken into account. For example, factors affecting delivery when geographically distributed resources are in place may be considered. For instance, overhead that is associated with project developments from diverse locations (e.g., communications and management overhead in executing project development from different locations), may need to be considered when determining the impacts on cost, schedule, quality, and risk. Factors such as time zone differences, holiday schedule differences, language, productivity, turnover rates, delivery deadline, and other factors affect the throughput of work on a given development project or account.

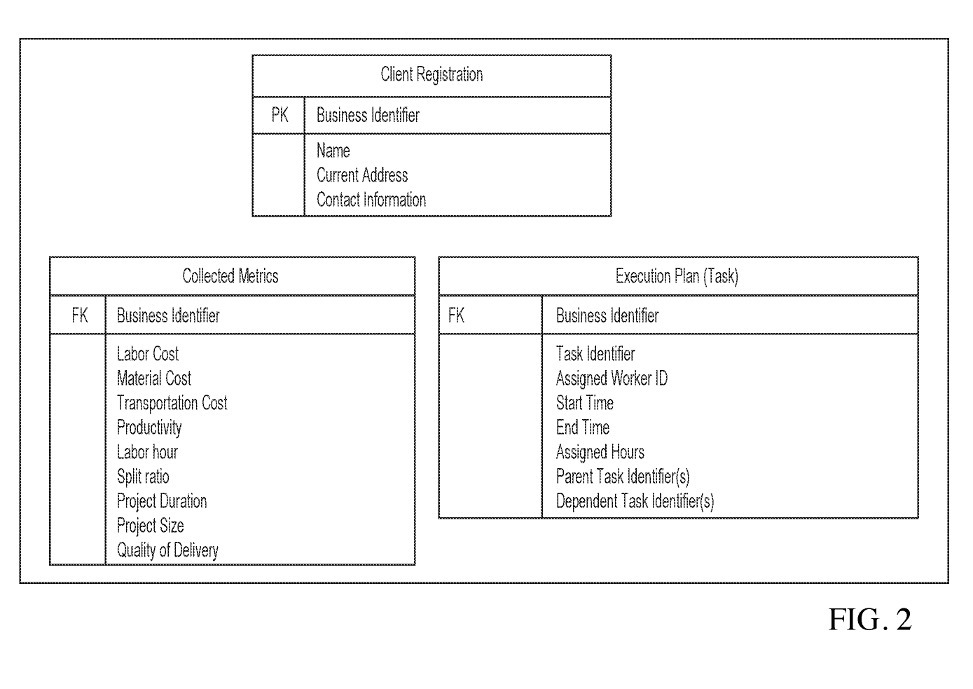

In one embodiment, to perform such development analysis more efficiently, a system and method may include creating a model from historical data. In one embodiment, fragmented information may be obtained from entities (e.g., businesses), collecting the data using a data format (e.g., shown in FIG. 2), creating a statistical and mathematical model to generate different execution plans, and assign tasks automatically to a proper team or individual.

In the present disclosure in one embodiment, a system is generated that assist (e.g., enterprises) in planning resources for completing projects in a geographical distributed environment, for example, where there are multiple geographical distributed teams that are able to complete the same tasks with different geographical distributed characteristics, and where the projects have constraints of budgets, time to delivery and requirements. The system in one embodiment allows a work flow process to collect the project metrics. In one embodiment, another work flow process with an estimation and price model based on and validated with empirical data, identifies and quantifies numerous factors that affect overall service delivery or product development productivity and risk. In one embodiment, the model elements include factors that may be unique to certain geographies or delivery groups and factors others that gauge affinities between development geographies or data centers. Factors such as differences in time zones, holiday schedules, language proficiency, historical productivity, turnover rates, skills sets, skill levels, and other factors, priorities in development effort and constraints concerning cost, schedule, risk, and quality may be considered. In one embodiment, the model allows an assessment of the local and affinity factors for various distributions of work to enable more accurate cost and risk estimates to be performed. In one aspect, this enables the user to optimize programs or projects and provides an analytical tool to determine project strategies.

In one embodiment, a methodology of the present disclosure jointly considers estimating, pricing, quality and risk assessment for software development, incorporates customer preferences (e.g., for whom the project is being developed) and factors that affect development, provides a way to characterize the customer preferences to complete a project, and provides a way to characterize productivity and cost factors that affect development. The methodology of the present disclosure in one embodiment jointly considers capabilities of the developer, preferences of the customer, the specifics of the way the work is broken up (referred to as task partitioning), in combination with external and internal factors affecting the development of a project.

A method and system of the present disclosure in one embodiment allow a work flow process to build an effective and efficient geographically dispersed team for solution development with the task and expense splits. Estimation of project quality and risk using various combinations of development resources may be provided, for example, in addition to the estimation and prediction of duration and cost. The method and system may include the following components: 1) productivity factor analyzer; 2) task splitter; 3) client (customer) indifference curves identifier, and 4) development optimizer. These elements consider the various factors, team skills, and team composition together to create an optimal task split and team split and schedule for solution development.

In one embodiment, the productivity factor analyzer is based on and validated with historical empirical data from existing geographically distributed and local projects, in conjunction with the available related data like time zone, turnover rate, and skill levels, which identifies and quantifies numerous factors that affect overall solution delivery or product development productivity and risk. The method and system in one embodiment apply a work flow to connect all the components together to allow a solution developer and client to optimize the development solution process. The work flow in one embodiment ensures the solution development in a geographically distributed environment with a proper task partition to reduce the geographically distributed communication barriers, cost saving and skill matching, in addition to the satisfaction of time and cost constraints.

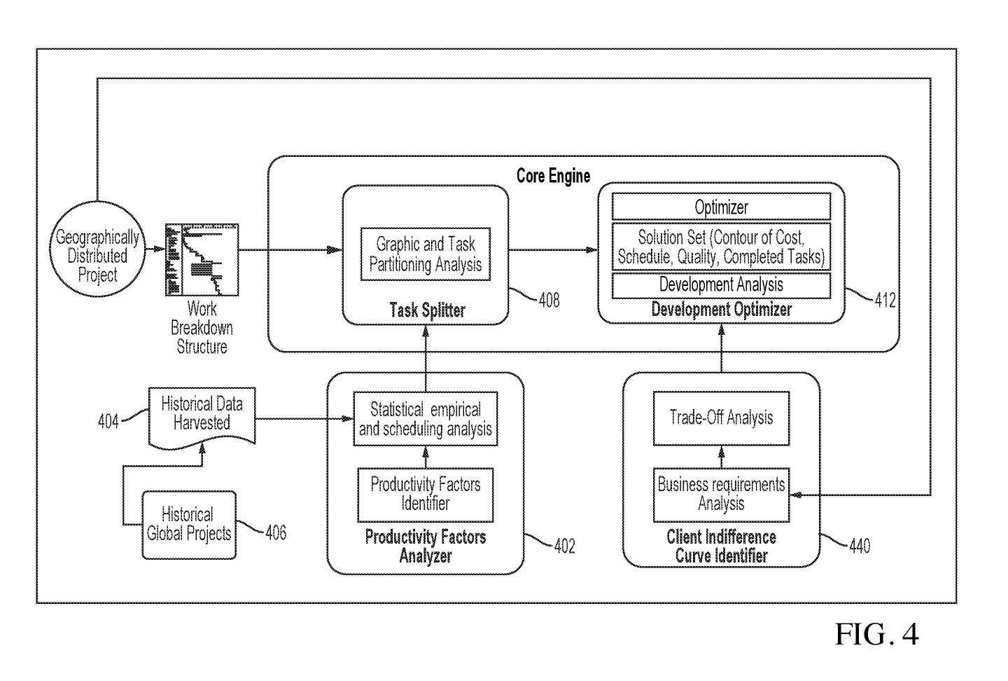

FIG. 4 is a diagram illustrating components of a system in the present disclosure in one embodiment for estimating the distributed project and risk using various combinations of development resources to create an optimal task split, team split, and schedule for project or solution development. The components execute or run on one or more processor or processing devices.

A productivity factor analyzer processing device 402 in one embodiment is based on and validated with historical data 404, which is uniquely applied to each engagement to consider factors, e.g., including time zone, turnover rate, and skill levels, which affect overall solution delivery or product development productivity and risk. The historical data 404 may be harvested from data associated with historical geographically distributed projects 406. The productivity factors analyzer processing device 402 enables the analysis of one or more productivity factors with one or more quantifier(s) to define the impact of the team composition and task split on project development. In one embodiment, the impact is quantified as changes of the solution metrics (e.g., key solution metrics) such as cost, quality, duration and required functions.

A task splitter processing device 408 in one embodiment enables identification of one or more split points to ensure minimization of negative impacts from the geographically distributed environment in communication and team collaboration and maximization of relevant applicable skills. The splitter device 408 in one embodiment also quantifies the split impact using a task dependency graph team parameters, e.g., time zone, communication needs, schedule requirement.

The task splitter processing device 408 in one embodiment creates different combinations of the team formation in terms of geographic locations, skills and number of tasks needed to be completed. By applying the additional requirement of the deadline, the system of the present disclosure can determine or compute the outcomes (cost, quality, the scope of work and deadline) using the information associated with geographical distribution (e.g., time zone, communication, and holiday mismatch, other cost factors, and others).

A client indifference curves identifier processing device 410 in one embodiment includes a set of questionnaires to identify the acceptable trade-off for various metrics (e.g., key metrics) of the client (e.g., cost, deadline, quality, risk, and required functions). The client indifference curves identifier processing device 410 in one embodiment develops a set of contours to justify the flexibility of selection different development options. The indifference curves define the flexibility of allowable different combinations of cost, quality, the scope of work and deadline, for example, the different combination of cost, quality, the scope of work and deadline that a project owner is willing to accept. It provides the information of making alternatives which are beneficial to the developers without sacrificing the interest of the project owner (e.g., client or customer).

A development optimizer processing device 412 in one embodiment calculates an optimal team composition and task splits by using a work flow to ensure the solution development in a distributed development environment with a proper team composition and task partition, to minimize the negative impact from geographically distributed communication collaboration, and to achieve cost saving and skill matching, in addition to the satisfaction of time, quality, risk, and cost constraints. The development optimizer processing device 412 in one embodiment may identify the best optimal task split and the team split based on the time, the cost required for the different task and team composition.

Candidates for input factors include collaboration factors such as time zone mismatch, holiday mismatch and language, productivity influencer factors such as turnover rates, skill sets (e.g., subject area specializations) and skill levels (e.g., depth of skill), and cost influencer factors such as exchange rate variability and other cost factors.

Additional candidate factors for consideration may include productivity differences within and across development organizations; Daily available time for geographically distributed team to communicate directly with local team, typically measured in hours; Minimum time required to achieve the sufficient information exchange in geographically distributed environment by communicating verbally; Understanding rate, .e.g., as a function of the communication of the two teams in the working language; Absolute time zone difference, pairwise, of the development team with a given separate development team, in hours; Working hours per day; Efficiency reduction for cross-language communication; Fraction of people involved in geographically distributed communication; The slippage factor for holiday impact; The number of non-overlapping holidays in the local and geographically distributed resource pools; The weighted average of the number of non-overlapping holidays, a ratio to measure the impact of non-overlapping holidays; The turnover rate during project execution, including both internal and external turnover rates; The time span required for new member to increase by X % in productivity (e.g., span measured in working days).

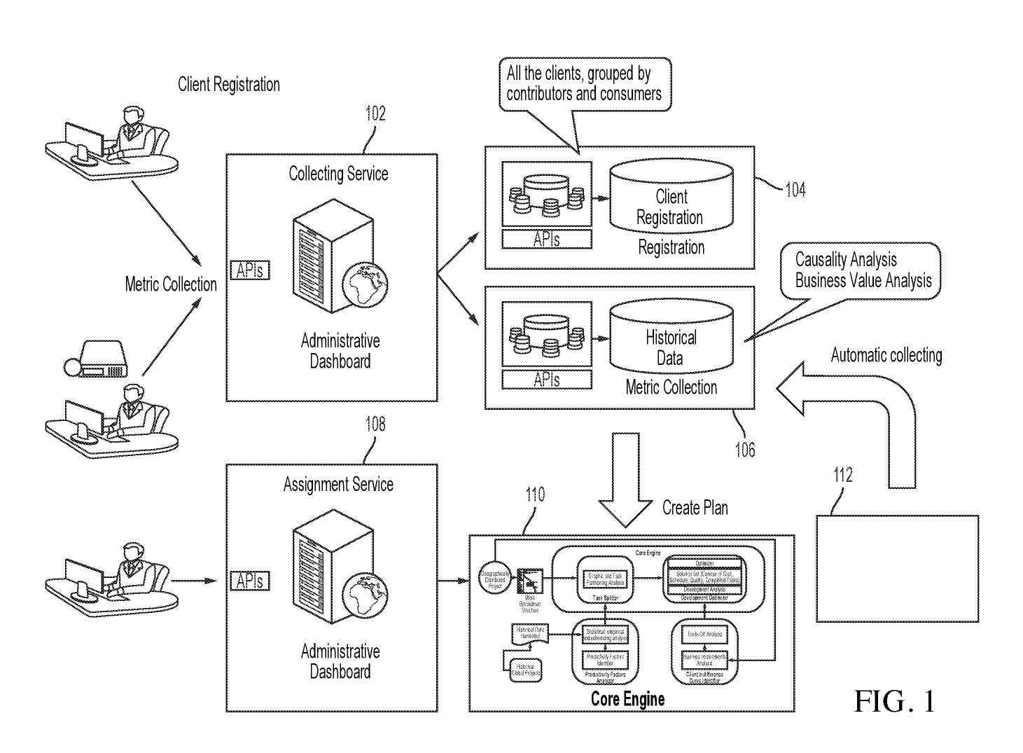

FIG. 1 is a flow diagram illustrating a method in one embodiment for an end-to-end system in one embodiment that collects the historical project metrics, estimates and creates an execution plan, and assigns tasks to workers. The system in one embodiment may include a software as a service (SaaS) platform.

At 102, a collecting service component allows a user to register and collect project execution metrics. The collecting service component has a dashboard and an application programming interface (API) to enable both manual registration, metrics submission, and/or automatic submission. At 104, a storage device stores users' information. The users include the historical project metrics providers (contributors), and consumers who use a developed model to create a project execution plan. At 106, another storage device may store various historical project metrics. At 108, an assignment service component allows a user to submit a request to create a project execution plan. The assignment service component has a dashboard and an API that enable both a manual submission and automatic submission. At 110, an analytic engine creates an estimation and execution plan for a project. At 112, a task is assigned to workers (e.g., target workers), for example, according to the execution plan created for the project. The components of the system execute or run on a hardware processor coupled with a memory device.

In one embodiment, task assignment is completed by automating an enablement agent (e.g., running on a hardware processor) to update an electronic calendar associated with the target workers, create the task assignment in an electronic work planner associated with the target workers, send alerts via, for example, an electronic-mail to notify the target workers. Other alert notification techniques may be utilized, such as text messaging. In one embodiment, a data format is defined for storing the historical project metrics in the memory device, wherein an application programming interface is defined for execution via the software as a service platform, and a dashboard is created for execution via the software as a service platform, the dashboard allowing the users to submit the historical project metrics and on-going project metrics, the system further comprising an automated agent created and deployed to automate probe and receive on-going project metrics.

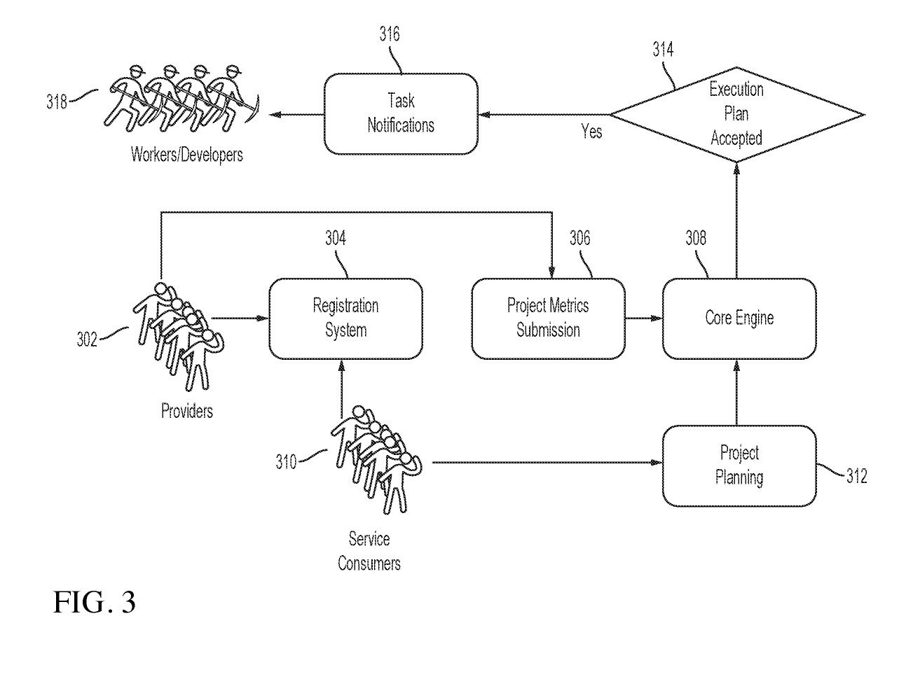

FIG. 3 is a diagram illustrating a data flow of an end-to-end system, for example, shown in FIG. 1, in one embodiment. Data providers 302 may register at a registration system 304 and submit project execution metrics 306 to a core engine 308. Service consumer 310 may also register at a registration system 304 and submit project planning information 312 to the core engine 308. The core engine 308 creates an estimation and execution plan for a project based on the project metrics submission 306 and project planning information 312. Based on accepting the execution plan 314, task notification 316 assigning tasks to workers is sent to works 318.

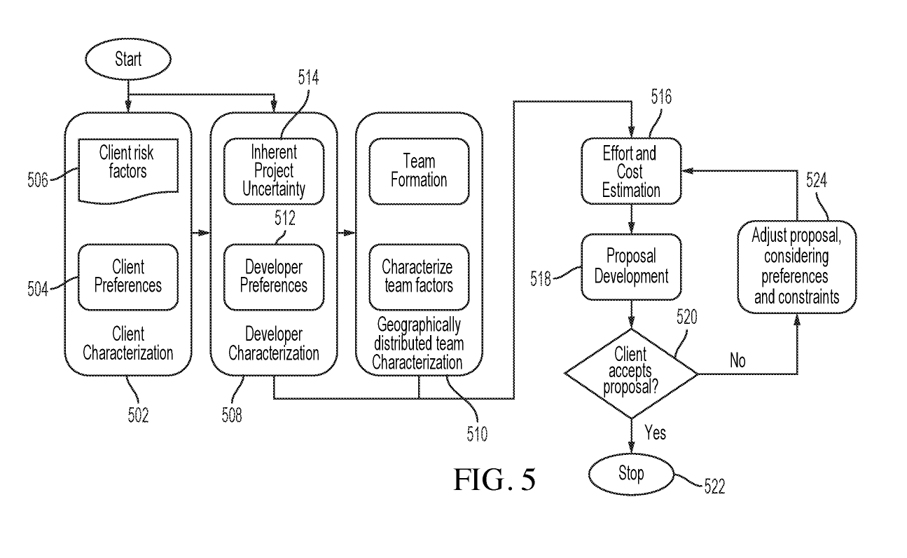

FIG. 5 is a flow diagram illustrating a method in one embodiment for estimating the distributed project and risk using various combinations of development resources to create an optimal task split, team split, and schedule for project or solution development. At 502, client characterization is performed. A client refers to an entity for which the project is or will be developed. For instance, client side risks and preferences are identified. Tradeoffs the client is willing to make may be captured with the client indifference function (e.g., cost versus requirements, duration, quality, and risk). Initial client offer (cost, requirements, time, quality, risk) may be obtained.

In determining client side preferences 504, an objective may be to characterize the importance the client places on given constraints: time, cost, quality, risk, etc., so that method in one embodiment may trade these items off in determining the best solution. The more that is understood about the client, the more accurate the method can make decisions about the project development. For example, a client might have more concerns about the project quality and delivery time compared with another client, and also place high importance on a longer-term relationship with a solution provider. Another client might place more importance on the cost of the project. Client side risk factors 506 may include risks from the client's business environment. For example, mission critical project may have more financial support from the client while a less critical project might be constrained by stricter budget control. Initial client offer may be obtained, e.g., during the negotiation process. This initial client offer tells the developer how much the client is willing to pay for a project based on a particular development time and requirements, and also provides an initial operating point in the client utility.

The method at 508 and 510 in one embodiment identifies development teams and associated attributes, for example, productivity and collaboration factors affecting teams, skill availability, cost model developer utility function and uncertainty. Developer metrics may be built while accounting for client indifference constraint. In developer evaluation, a developer assesses what geographically distributed teams are available and the attributes that are associated with those teams based on the client project. This process may include: Assessing team capabilities and availability; Determining productivity impact of utilizing a particular development team, including overhead needed for communication and coordination as well as additional time needed because of reduced communication effectiveness and increased holidays; Identifying any additional costs associated with a particular development team; Based on the type of work entailed, identifying uncertainty in project execution using historical data 514. The inherent uncertainty of a project 514 may be quantified using regression in the log-log scales. Additional models can incorporate other risks. Developer preferences 512 as a utility function may be assessed based on team usage and identified risks on both the client side and developer side.

At 516, effort and cost are estimated based on the developer characterization 508 and geographically distributed team characterization 510. Results may be compared with initial client offer. For example, the utility of initial client offer based on the understanding of the client preferences 504 may be compared with the utility of the developer based on developer preferences 512 and initial solution estimated at 516. If there is a discrepancy (e.g., developer utility is too low), the method may consider improving utility by adjusting one or more dimensions of the solution (e.g., longer development, or reduced requirements). For instance, processing at 508 and 510 may be repeated with adjusted dimensions to estimate another effort and cost that conforms better to the client utility. For example, the cost of a solution may be reduced with an increase in the delivery time in such a way that the client is still satisfied with the solution, but the developer utility has significantly increased. Other tradeoffs may be made with other dimensions. A new solution may be proposed to the client that makes an appropriate tradeoff.

Thus, for example, at 518, a proposal may be developed based on an effort and cost estimation performed at 516. At 520, it is determined whether the proposal is accepted. If so, the processing logic of the method stops at 522. Otherwise, the processing logic of the method adjusts one or more dimensions at 524 and repeats the effort and cost estimation at 216 with the adjusted one or more dimensions.

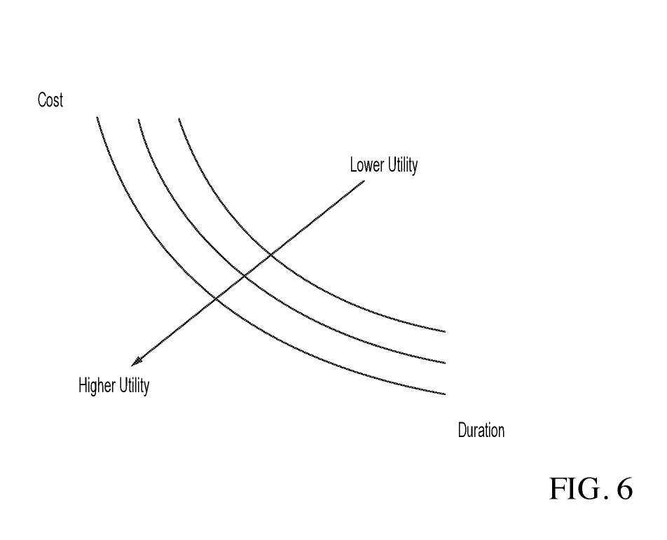

FIG. 6 is a diagram that illustrates client utility function in one embodiment of the present disclosure. The curves represent constant client utility. Any point on a particular curve equally satisfies the client. A developer may choose the point that is most acceptable. Different methods may be used to identify indifferent contours (curves in the figure). For example, a contour may be deduced from explicit information obtained from the client to identify the trade-off the client is willing to accept, in cost, quality, requirements and deadline adjustments. As another example, a contour may be identified using an analysis model, e.g., by mapping the business impact of the project using cost as the metrics; identifying the cost curve for different requirements, quality, and requirement, and completion time; creating the utility function as the combination of the previous two steps; and generating contours by fixing the value of utility function.

The following shows a simple example for determining client utility function. Consider that a client's primary concerns are 1) tolerable price and 2) duration of the development effort. In this example, the client utility function is built to capture these two factors. Based on client needs and historical data, the system of the present disclosure determines that a 1% increase in cost is equivalent to a 4% increase in development duration. The resulting indifference function is built to monotonically decrease with cost and delivery time (i.e., client prefers low cost and fast development).

Generally, indifferent contours may be identified, for example, using an analysis model, for example, mapping the impact of a project with cost and duration as metrics, identifying the utility curve for different requirements such as quality and completion time, creating a utility function as the combination of the mapping and the identifying. Contours may be generated by fixing the value of utility function. Indifferent contours may also be identified, for example, from discussions with the client or customer the trade-off the client is willing to adjust, for example, in factors such as the cost, quality, requirements, and deadline.

Different project execution strategies may be generated based on the indifference curve. The strategies may include changing the project duration and reducing the development cost. The execution cost and the project duration may be impacted depending on how a geographically distributed team is formed.

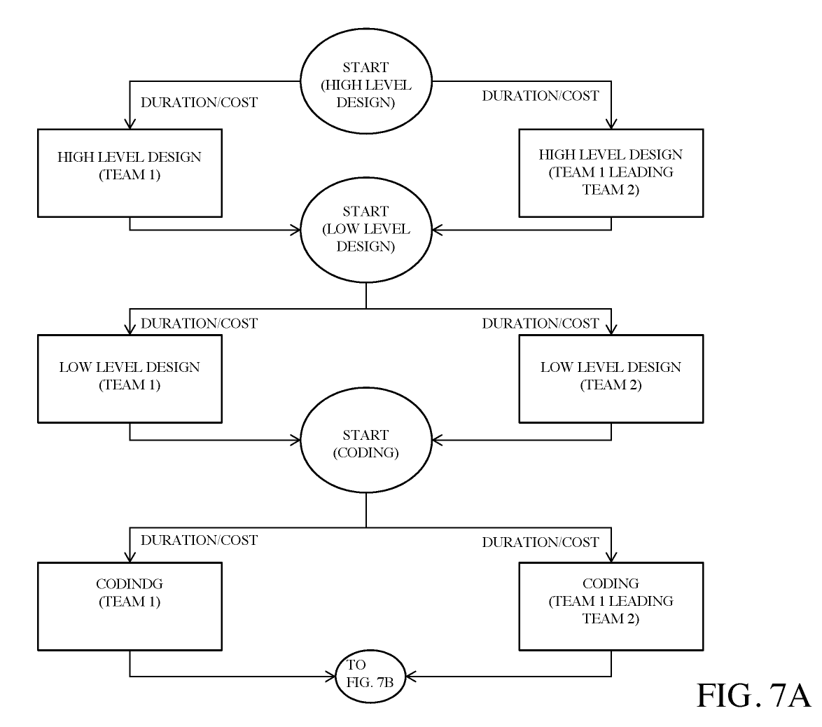

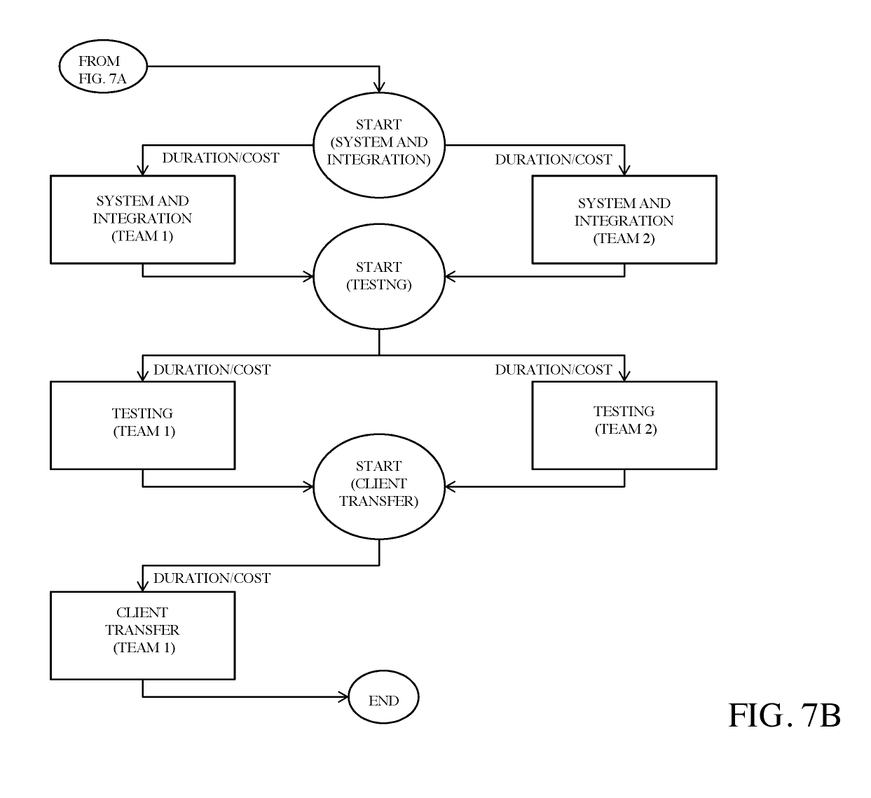

FIG. 7A and FIG. 7B illustrate an example of a task dependency tree in one embodiment of the present disclosure. A project can be completed using different teams. The different routes from the start to the end reflect the different selection of the execution plan. The dependency tree may be used to calculate the different project execution plans and identify the different time and duration based on time/cost required for each task and the dependence for completion for any given team composition.

The task dependency tree is generated based on a work breakdown structure. The edge between the nodes contains the project related metrics, such as the time to complete the tasks, the duration. Those metrics can be computed based on the estimation from historical data on effort, site/task productivity, inter-site coordination factors and communication requirement between sites. The following illustrates examples of determining communication impacts from a distributed team.

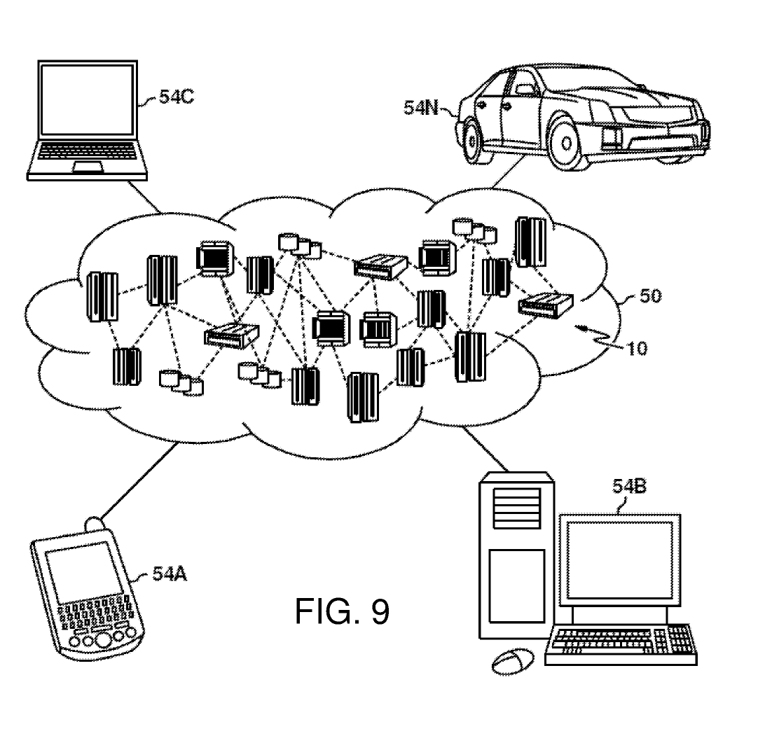

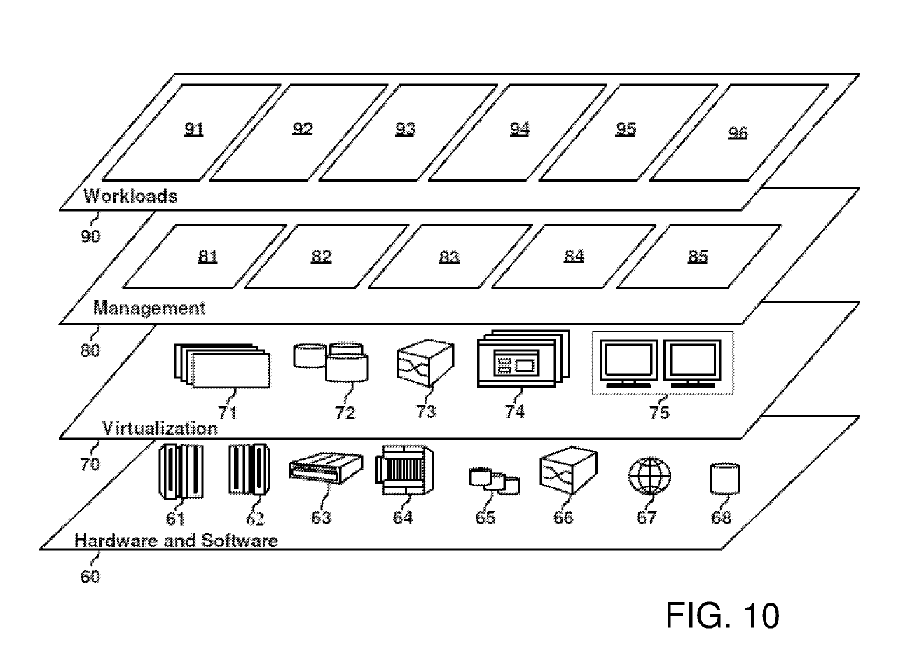

FIG. 9 illustrates a cloud computing environment in one embodiment of the present disclosure. FIG. 10 shows a set of functional abstraction layers provided by cloud computing environment in one embodiment of the present disclosure.

It is understood in advance that although this disclosure may include a description of cloud computing, implementation of the teachings recited herein is not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to scale out and rapidly released to scale in quickly. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely by an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is a service oriented with a focus on statelessness, low coupling, modularity, and semantic interoperability. At the heart of cloud computing is an infrastructure that includes a network of interconnected nodes.

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or addressable network connection (e.g., using a web browser).

Referring now to FIG. 10, a set of functional abstraction layers provided by cloud computing environment 50 (FIG. 9) is shown. It should be understood in advance that the components, layers, and functions shown in FIG. 10 are intended to be illustrative only, and embodiments of the invention are not limited thereto. As depicted, the following layers and corresponding functions are provided:

Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and distributed development processing 96 of the present disclosure.

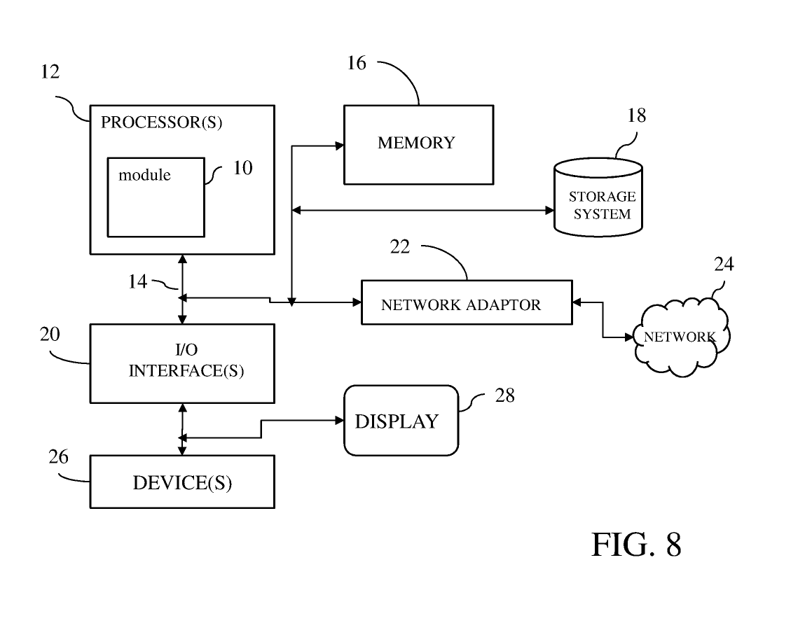

FIG. 8 illustrates a schematic of an example computer or processing system that may implement the system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 8 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12 or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, and external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A system for collecting, assessing, planning and executing for a distributed development project, comprising:
a software as a service platform allowing users to contribute historical project metrics, and to submit a request for project planning, execution plan, and task split;
a productivity factor analyzer processing device running on one or more hardware processors, based on the historical project metrics, performing analysis of one or more productivity factors with one or more quantifiers to define an impact of a team composition and task split on a project development;
a task splitter processing device running on one or more of the hardware processors, performing identification of one or more split points that minimize negative impacts from a geographically distributed environment in communication and team collaboration;
an indifference curve identifier processing device running on one or more of the hardware processors, identifying trade-offs for client metrics and developing a set of contours for different development options; and
a development optimizer processing device running on one or more of the hardware processors, determining the team composition and task splits based on the one or more split points, the set of contours, and the impact of a team composition and task split on the project development
the software as a service platform assigning the task splits to corresponding target workers.

2. The system of claim 1, wherein the software as a service platform comprises a dashboard and an application programming interface (API) to allow the users to register, allow registered users to submit metrics data associated with completed and on-going projects.

3. The system of claim 1, wherein the task splitter quantifies the impact using a task dependency graph associated with geographically distributed teams.

4. The system of claim 1, wherein the different development options comprise options associated with the different combination of cost, quality, scope of a project, and deadline.

5. The system of claim 1, wherein the task splitter processing device generates different combinations of teams with attributes that include geographic location, skills, and a number of tasks needed to be completed.

6. The system of claim 1, wherein a contour in the set of contours is generated by fixing a value of a utility function, the utility function created as a combination of mapping an impact of the project development with cost and duration as metrics and identifying a utility curve for a plurality of different requirements comprising quality and completion time.

7. The system of claim 1, wherein task assignment is completed through automating an enablement agent to update an electronic calendar associated with the target workers, create the task assignment in an electronic work planner, send alerts via an electronic-mail to notify the target workers.

8. The system of claim 1, a memory device coupled to the one or more hardware processors, wherein a data format is defined for storing the historical project metrics in the memory device, wherein an application programming interface is defined for execution via the software as a service platform, and a dashboard is created for execution via the software as a service platform, the dashboard allowing the users to submit the historical project metrics and on-going project metrics, the system further comprising an automated agent created and deployed to automate probe and receive on-going project metrics.

9. A computer-implemented method of assessing and planning for a distributed development project, the method performed by one or more hardware processors, comprising:
analyzing one or more productivity factors with one or more quantifiers to define an impact of a team composition and task split on a project development;
identifying one or more split points that minimize negative impacts from a geographically distributed environment in communication and team collaboration;
identifying trade-offs for client metrics and developing a set of contours for different development options; and
determining the team composition and task splits based on the one or more split points, the set of contours, and the impact of a team composition and task split on the project development.

10. The method of claim 9, wherein the impact is quantified using a task dependency graph associated with geographically distributed teams.

11. The method of claim 9, wherein the different development options comprise options associated with different combination of cost, quality, scope of a project, and deadline.

12. The method of claim 9, wherein the different combinations of teams with attributes that include geographic location, skills, and a number of tasks needed to be completed are generated.

13. The method of claim 9, wherein a contour in the set of contours is generated by fixing a value of a utility function, the utility function created as a combination of mapping an impact of the project development with cost and duration as metrics and identifying a utility curve for a plurality of different requirements comprising quality and completion time.

14. The method of claim 8, wherein a task assignment is completed through automating an enablement agent to update an electronic calendar associated with target workers, to create the task assignment in a work planner associated with target workers, and to send alerts to notify the target works.

15. A computer readable storage medium storing a program of instructions executable by a machine to perform a method of assessing and planning for a distributed development project, the method comprising:
allowing users via a software as a service platform to contribute historical project metrics, and to submit a request for project planning, and execution plan and task split; analyzing one or more productivity factors with one or more quantifiers to define an impact of a team composition and task split on a project development;
identifying one or more split points that minimize negative impacts from a geographically distributed environment in communication and team collaboration;
identifying trade-offs for client metrics and developing a set of contours for different development options; and
determining the team composition and task splits based on the one or more split points, the set of contours, and the impact of a team composition and task split on the project development.
assigning the task splits to targeted workers.

16. The computer readable storage medium of claim 15, wherein the impact is quantified using a task dependency graph associated with geographically distributed teams.

17. The computer readable storage medium of claim 15, wherein the different development options comprise options associated with the different combination of cost, quality, scope of a project, and deadline.

18. The computer readable storage medium of claim 15, wherein the different combinations of teams with attributes that include geographic location, skills, and a number of tasks needed to be completed are generated.

19. The computer readable storage medium of claim 15, wherein a contour in the set of contours is generated by fixing a value of a utility function, the utility function created as a combination of mapping an impact of the project development with cost and duration as metrics and identifying a utility curve for a plurality of different requirements comprising quality and completion time.
